(19) United States
(12) Patent Application Publication
(10) Pub. No.: US 2005/0075756 A1
(43) Pub. Date: Apr. 7, 2005

(54) Data-collecting system and robot apparatus

(76) Inventor: Tatsuo Itabashi, Tokyo (JP)

Correspondence Address: William S. Frommer, Esq.;FROMMER LAWRENCE & HAUG LLP, 745 Fifth Avenue, New York, NY, 10151, US

(21) Appl. No.: 10/850,071

(22) Filed: May 20, 2004

(30) Foreign Application Priority Data
May 23, 2003 (JP) 2003-146805

(51) Int. Cl. G06F 19/00

(52) U.S. Cl. 700/245

(57) ABSTRACT

A robot 20 periodically moves along specified routes in a user's living space 1, collecting the ID data items of objects 40 existing in the living space 1. Each object 40 has a radio tag 10, which stores the ID data of the object 40. The robot 20 has a communications unit 26. While the robot 20 is moving, the unit 26 keeps transmitting an electric wave to which the radio tags 10 can respond. Upon receiving the electric wave, each radio tag 10 transmits the ID data of the object 40. The robot 20 receives the ID data and generates property data by adding, to the ID data, the data representing the time and position at which the radio tag 10 has transmitted the ID data. The property data shows what exists where and when. A data-managing apparatus 30 has a meta-data recording unit 31, which converts the property data to meta data. The meta data can be used in various types of data-processing apparatuses.

### BACKGROUND OF THE INVENTION

1. Field of the Invention

The present invention relates to a data-collecting system that collects data about objects existing in a predetermined space, and also to a robot apparatus for use in the data-collecting system.

2. Description of the Related Art

The communications environment known as “ubiquitous” has been constructed in recent years. Ubiquitous is an environment in which anyone can access any site in any data network, such as the Internet, at any place and any time. Terminals that can access the data networks are not limited to personal computers and mobile telephones. Rather, home electric appliances such as refrigerators and microwave ovens, automobiles, automatic vending machines, and the like can access the data networks.

Researchers are now devising data techniques for providing a ubiquitous environment that is user-friendlier than the existing one. To construct such a communications environment, the data about people and the data about the objects that exist in man's living space should be collected, classified, and converted to meta data. The meta data can be managed in a single way.

Hitherto, however, the management of the data about the objects existing in man's living space has been resorted to people's memory or to the record manually made in notebooks or electronic pocket-diaries. The memory of any person is limited. The data of any object, manually recorded, must be rewritten whenever the state of the object changes. If the data recorded is not rewritten, it no longer represents the present state of the object. If not rewritten, the data is not reliable enough to be input for computer processing or is not so sufficient as is desired.

### SUMMARY OF THE INVENTION

The present invention has been made in view of the foregoing. An object of the invention is to provide a data-collecting system that reliably collects data about the objects existing in a space in which a person lives. Another object of the invention is to provide a robot apparatus for use in the data-collecting system.

A data-collecting system according to this invention is designed to collect data about objects existing in a specified space. The system comprises: radio tags provided on the objects, each recording an ID data item identifying one object; a robot apparatus which moves in the specified space at regular intervals to collect ID data items recorded in the radio tags; and a data-managing apparatus which manages the ID data items collected by the robot apparatus.

A robot apparatus according to this invention comprises: a map-data storage means for storing map data representing the geography of a specified space; a route-data storage means for storing route data representing routes existing in the specified space; a mobile means which moves in the specified space at regular intervals in accordance with the map data and the route data; and an ID-data reading means for reading ID data items from radio tags existing in the specified space, while being driven by the mobile means.

The robot apparatus moves, acting as a data-collecting apparatus to collect the ID data items of the radio tags at regular intervals. Thus, the robot apparatus can collect correct data showing what exists when and where.

Since the data-collecting apparatus moves in a space, along a prescribed route. The route can be changed to another, so that the apparatus may move in another space to collect data. Furthermore, it is easy for the user to input the data showing a plan of any desired living space, to the data-collecting apparatus, because the user needs only to draw the plan of the desired space.

According to the present invention, the data about the objects existing in the specified space is converted to meta data, which can be used in the ubiquitous network. Moreover, the data items about the same object can be accumulated and used to determine how the state of the object changes with time.

### BRIEF DESCRIPTION OF THE SEVERAL VIEWS OF THE DRAWING

FIG. 1 is a plan illustrating a living space;

FIG. 2 is a diagram showing the configuration of a radio tag;

FIG. 3 is a block diagram depicting the configuration of a data-collecting system that collects data about the objects belonging to the user of the system;

FIG. 4 is a flowchart explaining how the state-notifying unit operates in the data-collecting system;

FIG. 5 is a flowchart describing a procedure of collecting data;

FIG. 6 is a flowchart showing another procedure of collecting data; and

FIG. 7 is a flowchart illustrating a procedure of collecting data from the radio tags that exist in a closed space.

### DETAILED DESCRIPTION OF THE INVENTION

A data-collecting system 100 according to the present invention will be described with reference to the accompanying drawings. The data-collecting system 100 is designed to collect data representing when and where the user's things exist. The system 100 is provided in the user's living space, such as his or her house or office.

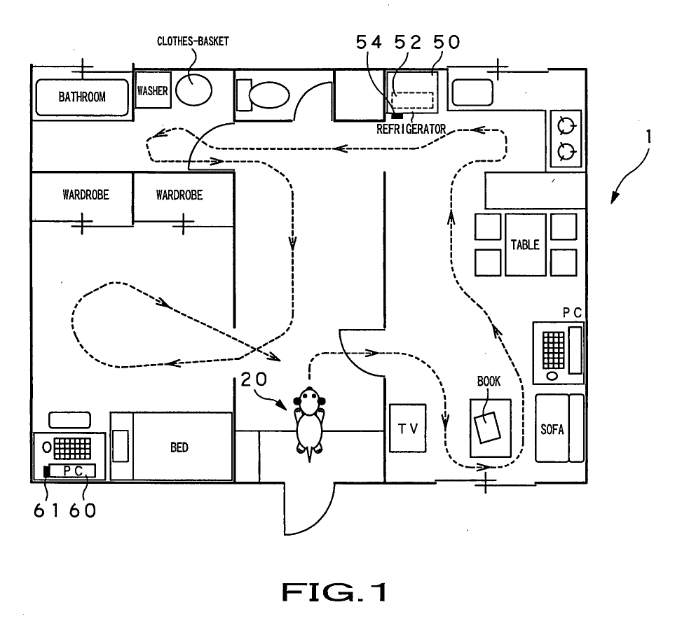

FIG. 1 is a plan view of the user's living space 1, i.e., his or her house. Various objects 40 exist in the living space 1. Among these objects 40 are a bed, wardrobes, a personal computer (PC) 60, books and clothes. They are the user's property. A radio tag 10 called “RFID” is attached to or contained in each object 40.

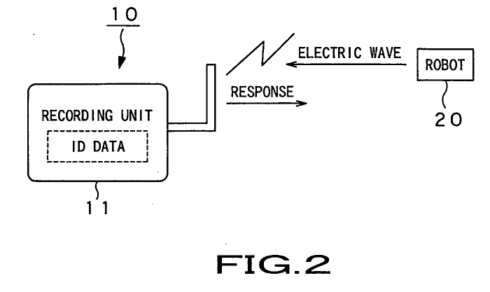

As FIG. 2 shows, the radio tag 10 has a recording unit 11 and an antenna 12. The recording unit 11 records the ID data of the object 40. The antenna 12 receives an electric wave transmitted from a robot 20 and transmits a response to the robot 20. Upon receiving an electric wave from outside the tag 10, at a predetermined electric-field intensity, the antenna 12 generates power from the electric wave. Using the power, the antenna 12 transmits the ID data recorded in the recording unit 11. The radio tag 10 has been attached to the object 40 when the object 40 is manufactured. It is utilized in the production management and the physical-distribution management. The radio tag 10 is available in two types. The first type holds ID data that uniquely identifies the object 40. The second type holds ID data that identifies the classification of the object 40. Radio tags of the first type are attached to durable products such as home electric appliances, software items or the like. Radio tags of the second type are attached to expendables such as paper sheets and foods.

In the data-collecting system 100 shown in FIG. 1, the robot 20 collects the data about the objects owned by the user. The robot 20 periodically moves in the user's living space 1. While moving in the space 1, the robot 20 collects the ID numbers uniquely assigned to the objects 40, which are recorded in the radio tags 10 on the objects 40.

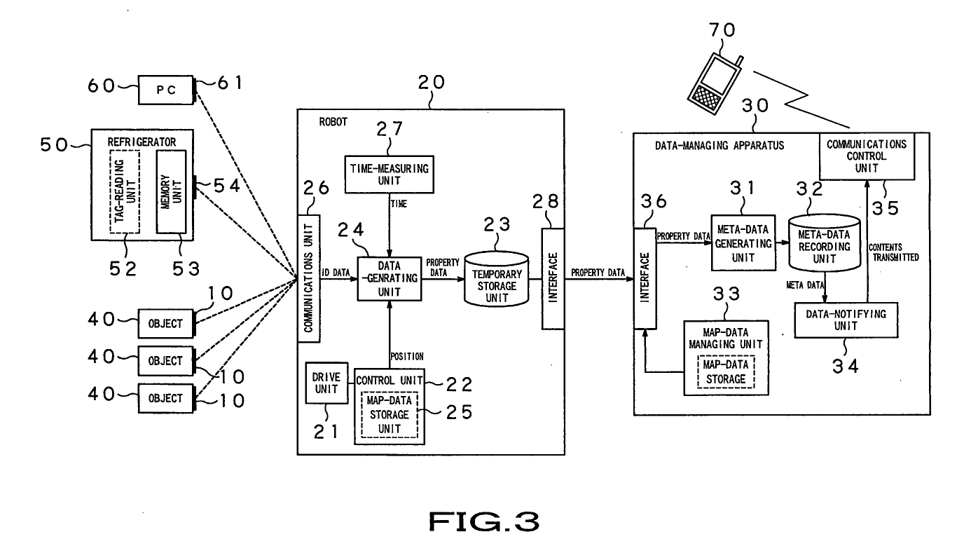

As FIG. 3 depicts, the robot 20 includes drive units 21, an operation control unit 22, a communications unit 26, a temporary storage unit 23, and a data-generating unit 24. The drive units 21 are operated so that the robot 20 may move. The operation control unit 22 controls the drive units 21. The communications unit 26 performs communication with the radio tags 10. The temporary storage unit 23 temporarily stores the data received from any radio tag 10. The data-generating unit 24 generates object ID data from the ID number recorded in any radio tag and the time and position at which the ID number has been acquired.

The drive units 21 are arranged at the leg and arm joints of the robot 20. When supplied with electric power, these components drive the legs and arms of the robot 20. The control unit 22 has a map-data storage 25. The operation control unit 22 detects the displacements of the drive units 21. In accordance with the displacements detected, the control unit 22 controls the drive units 21 to make the robot 20 walk along various routes represented by the map data stored in the map-data storage 25. The robot 20 has an obstacle-detecting unit (not shown) and can walk along the routes, without colliding with the obstacles standing in the way. The control unit 22 finds the position of the robot 20 from the amount of motion of each drive unit 21 and generates the data representing the position the robot 20 takes at present. This data is output to the data-generating unit 24.

The communications unit 26 keeps transmitting electric waves that the radio tags 10 can receive. Upon receipt of an electric wave from the robot 20, each radio tag 10 transmits a response. The robot 20 receives the response. In the robot 20, the data-generating unit 24 adds the data showing the time and position at which the radio tag 10 has responded, to the ID number of the radio tag 10, thus generating property data. The property data represents what (ID number) exists and when (time) and where (position). The time data is output from the time-measuring unit 27 incorporated in the robot 20.

The data-collecting system 100 has a data-managing apparatus 30. The apparatus 30 includes a meta-data generating unit 31 and a meta-data recording unit 32. The meta-data generating unit 31 converts the property data to meta data, which is recorded into the meta-data recording unit 32. The meta data is in a unified format and can therefore be used in any ubiquitous network.

The data-managing apparatus 30 has a map-data managing unit 33. The user may input the data representing the map of the living space 1 (FIG. 1), the fixed objects 40 existing in the space 1 and various routes for the robot 20, into the map-data storage unit provided in the data-managing unit 33. This data is transferred to the robot 20. The map-data managing unit 33 receives the position data transmitted from the robot 20 and plots the positions represented by the position data, in the map of the living space 1. A data-notifying unit 34 (later described) uses the map data containing items showing these positions plotted, in order to inform the user of any positions in the space 1, where a trouble has occurred.

The term “fixed objects” means objects 40 that cannot or would not be moved in the living space 1. They are the bathtub, kitchen range, pieces of furniture, and the like. Radio tags 10 may be put on the fixed objects 40. Then, the data transmitted from the radio tags 10 help the robot 20 determine where it is.

The data-managing apparatus 30 further has a data-notifying unit 34 that is designed to inform the user of the state of each object. This unit 34 detects the state of an object from the property data. For example, many clothes may lie around a clothes-basket set in the bathroom. In this case, the data-managing apparatus 30 transmits data to the user's mobile terminal 70, advising him or her to wash the clothes. If the bankbooks do not exist where they should, the unit 34 will transmit data to the user's mobile terminal 70, informing the user that there may have been a theft. The data is transmitted via the communications control unit 35 that is incorporated in the data-managing apparatus 30.

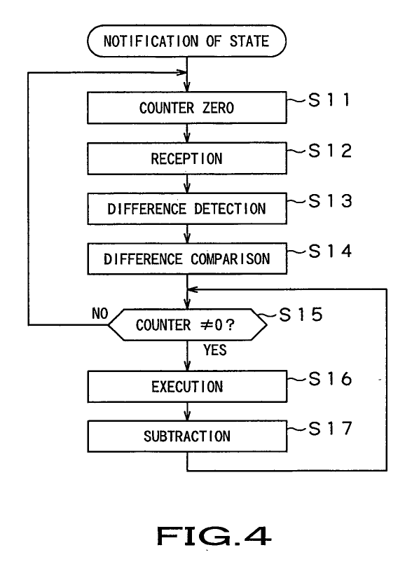

The data-notifying unit 34 finds a difference between the latest property data the apparatus 30 has acquired and the property data the apparatus 30 acquired in the past. On the basis of the difference, the unit 34 determines the present state of an object. For example, the data-managing apparatus 30 may receive no data about a bankbook, though it received the data about the bankbook some time ago. In this case, the data-notifying unit 34 determines that the bankbook has been stolen. FIG. 4 is a flowchart that shows how the state-notifying unit 34 operates. First, the unit 34 resets the count of a trouble counter to zero (Step S11). Next, the unit 34 receives the property data transmitted from the robot 20 (Step 12). The unit 34 compares the property data with the immediately preceding property data it has received, thus finding a difference for each object having a radio tag 10 (Step S13). The trouble counter counts any difference that is greater than a preset value (Step S14). Hence, the greater the count, the more objects have come into trouble.

Upon finding differences for all objects having a radio tag 10, the data-notifying unit 34 determines whether the count of the trouble counter is other than zero (Step S15). If NO in Step S15, namely if the count is zero, the objects having a radio tag 10 have no troubles. In this case, the unit 34 does nothing, and the process returns to Step S11. If YES in Step S1, that is, if the count is other than zero, the process goes to Step S16. In this case, the data-notifying unit 34 transmits the data indicative of the first trouble found, to the user's mobile terminal 70 (Step S16). The unit 34 then decreases the count of the trouble counter by one (Step S17). The process returns to Step S15. Step S16 and Step S17 are repeated until it is determined in Step S15 that the count of the trouble counter decreases to zero. When the count becomes zero, the process returns to Step S11.

The user can set the conditions for the data-notifying unit 34 to determine whether any object 40 having a radio tag 10 has come into trouble. If the user may lend an object 40 to someone, he or he may register the period of lending the object 40. Then, once the period has expired, the data-notifying unit 34 retrieves the property data about the object 40 and can determine, from this data, whether the object 40 has been returned to the user.

The data-managing apparatus 30 has an interface 36 that achieves communication with the robot 20. The interface 36 may be either wireless or wired. If the interface 36 is a wireless one, the robot 20 can transmit the data it has acquired to the data-managing apparatus 30, while walking in the living space 1 (FIG. 1). If the interface 36 is a wired one, the robot 20 needs to reach a base station where it can be connected to the data-managing apparatus 30. The robot 20 keeps storing the data. The data is transmitted to the apparatus 30 after the robot 20 reaches the base station and is electrically connected to the apparatus 30.

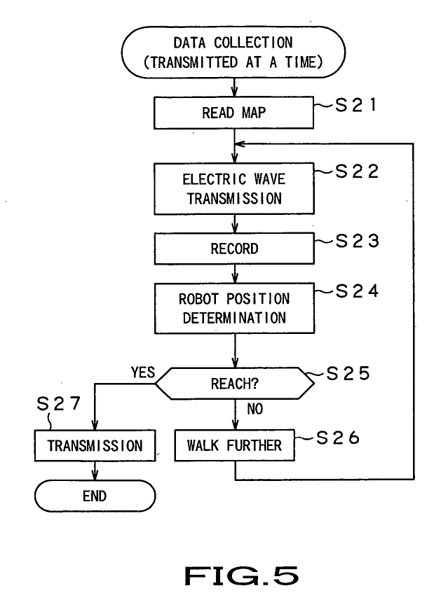

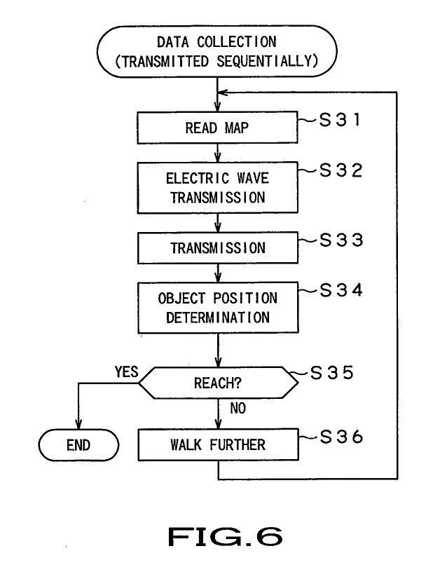

FIG. 5 and FIG. 6 represent two procedures that the robot 20 may perform to collect data. The robot 20 performs the procedure of FIG. 5 to transmit the data about all objects 40 having a radio tag 10 each, to the data-managing apparatus 30. First, the map data that shows the routes the robot 20 may walk along is read from the map-data storage 25 (Step S21). Then, the communications unit 26 transmits an electric wave and waits for a response that may come from any radio tag 10 (Step S22). When the communications unit 26 receives responses from the radio tags 10, the ID numbers of the radio tags, and the times and positions when and where the tags 10 transmit responses are recorded in the form of a list (Step S23). Then, the robot 20 detects the ID number of any fixed object 40 from the list recorded within a prescribed period. Thus, the robot 20 determines its position from the ID number thus detected (Step S24). Upon determining its position, the robot 20 deletes the ID data of the fixed object 40 detected, from the list.

The robot 20 compares its position with the position of the base station to determine whether it has reached the base station (Step S25). If NO in Step S25, the robot 20 walks further (Step S26). If YES in Step S25, the robot 20 is connected to the base station. The list of the data items about the objects is transmitted from the robot 20 via the base station to the data-managing apparatus 30 (Step S27).

The procedure that the robot 20 performs to transmit the data items about all objects 40, one after another, to the data-managing apparatus 30, will be explained with reference to FIG. 6. First, the map data that shows the routes the robot 20 may walk along is read from the map-data storage 25 (Step S31). Then, the communications unit 26 transmits an electric wave and waits for a response that may come from any radio tag 10 (Step S32). When the communications unit 26 receives a response from a radio tag 10, the robot 20 transmits the ID number of the radio tag 10 and the time and position when and where the radio tag 10 transmits response, to the data-managing apparatus 30 (Step S33). From this ID data, the apparatus 30 determines the position of the object 40 that has the radio tag 10 (Step S34). The apparatus 30 then determines whether the object 40 lies at the end of the route that the robot 20 should walk (Step S35). If YES in Step S35, the procedure is terminated. If NO in Step S35, the apparatus 30 causes the robot 20 to keep walking to collect data (Step S36), until the robot 20 arrives at the end of the route.

In either procedure (FIG. 5 or FIG. 6), the robot 20 may receive data several times from the same radio tag 10. It is necessary to determine whether responses are coming from the same tag. Otherwise, these responses would be regarded as transmitted from different radio tags. Moreover, the robot 20 may simultaneously detect the position-data items of several objects 40. In this case, it is necessary to determine which position-data items are correct, on the basis of all position-data items detected and the estimated position of the robot 20. These decisions are made in the robot 20 in the procedure of FIG. 5, and in the data-managing apparatus 30 in the procedure of FIG. 6.

A modified method of collecting data will be described below. Electric waves emitted from the robot 20 cannot reach the radio tags 10 attached to anything stored in a closed space, such as a refrigerator 50 that stands in the living space 1. A data-outputting device 51 is used. The device 51 is designed to collect data from the radio tags 10 existing in the refrigerator 50 and to output the data to the robot 20. As FIGS. 1 and 3 depict, the data outputting device 51 has a tag-reading unit 52, a memory unit 53 and a data-transmitting unit 61. The tag-reading unit 52 is provided in the refrigerator 50. The memory unit 53 temporarily stores the ID data items of the objects stored in the refrigerator 50 and having a radio tag 10 each. The data-transmitting unit 61 transmits the ID data items stored in the memory unit 53 to the robot 20.

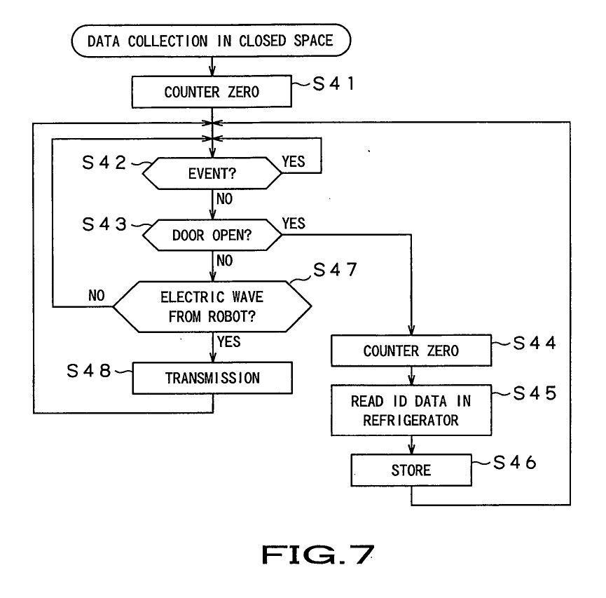

FIG. 7 represents the procedure of collecting data from the radio tags 10 provided on the objects 40 that the refrigerator 50 stores. First, the event counter incorporated in the data-outputting device 51 is reset to the zero-count (Step S41). The device 51 determines whether any event has taken place in the refrigerator 50 (Step S42). If YES in Step S42, the device 51 determines whether the event is the movement (opening or closing) of the door on the refrigerator 50 (Step S43). If YES in Step S43, the count of the event counter is set to zero (Step S44). Then, the tag-reading unit 52 reads the ID data items of the objects 40 stored in the refrigerator 50 (Step S45). The ID data items thus read are stored into the memory unit 53 (Step S46).

If NO in Step S43, that is, if the event is neither the opening of the door nor the closing of the door, the data-outputting device 51 determines whether the event is the receipt of an electric wave transmitted from the robot 20 (Step S47). If YES in Step S47, the device 51 transmits the ID data items stored in the memory unit 53, to the robot 20 (Step S48). If NO in Step S47, that is, if the event is not the receipt of the electric wave from the robot 20, the process returns to Step S42.

In the ubiquitous network, the electronic data to which the user has claimed copyright may be regarded as user's property. The copyrighted electronic data is, for example, music data and application software. The data-collecting system 100 therefore collects the serial numbers assigned to, for example, the application software items that the user owns as ID data items. To transmit the copyrighted electronic data recorded in a hard disc or a recording medium, to the robot 20, a peripheral apparatus such as PC 60 has a data-transmitting unit 61 as is illustrated in FIGS. 1 and 3. Hence, the system 100 can collect not only the data about the objects 40 that are tangible property, but also the copyrighted electronic data that is intangible property.

As has been described, in the data-collecting system 100 according to this invention, the robot 20 collects the ID data items of the objects 40, from the radio tags 10 that are provided on or in the objects 40, respectively. Every time the robot 20 collects these data items, it adds the data showing the time and position at which each radio tag 10 has responded, to the ID number of the radio tag 10, thus generating property data. The property data represents what exists when and where. The robot 20 collects property data items at regular intervals. The property data items collected are accumulated in the data-managing apparatus 30.

The property data items accumulated in the data-managing apparatus 30 form time-serial information. Thus, if the latest data item and the immediately proceeding data item, both acquired of the same object 40, are compared, it can be determined whether the object 40 has been moved or lost.

The robot 20 stores the map data showing the geography of the living space 1 and the route data showing the routes it may walk along in the living space 1. It is the user who prepares the map data. The map-data managing unit 33 generates a graphical interface. The user can use the graphical interface to draw a plan of the living space.

The present invention is not limited to the embodiment described above. Modifications can be made within the scope of the invention. In the embodiment, the map of the living space, prepared by the map-data managing unit 33, is a two-dimensional map. Instead, the unit 33 may generate a three-dimensional map of the living space. Further, in the process of drawing the plan of the living space, data times representing the room owners may be input. In this case, data items, each identifying an object, the room holding the object and the owner of the object, may be recorded and associated with the data items representing the room owners.

Moreover, the ID data items of the users of the living space may be registered so that only the users registered can access the data-managing apparatus 30 from outside the living space through the external data networks.

1. A data-collecting system for collecting data about objects existing in a specified space, comprising:
radio tags provided on the objects, each storing an ID data item identifying one object;
a robot apparatus which moves in the specified space to collect ID data items stored in the radio tags; and
a data-managing apparatus which manages the ID data items collected by the robot apparatus.

2. A data-collecting system according to claim 1, wherein the robot apparatus comprises:
tag-position determining means for determining a position that each radio tag takes in the specified space, from the position of the robot apparatus; and
property-data generating means for generating property data by adding, to the ID data time stored in each radio tag, data items representing the position and time at which the ID data item has been collected.

3. A data-collecting system according to claim 1, wherein the robot apparatus comprises route-data storage means for storing route data representing routes, and moves along the routes represented by the route data.

4. A data-collecting system according to claim 3, wherein the data-managing apparatus comprises:
plan-drawing means for drawing a plan of the specified space;
route-drawing means for drawing routes in the plan drawn by the plan-drawing means; and
route-data output means for outputting route data to the robot apparatus, said route data representing the routes drawn by the route-drawing means, and
the robot apparatus moves along the routes represented by the route data output by the route-data output means.

5. A data-collecting system according to claim 1, wherein the robot apparatus comprises:
tag-position storage means for storing the ID data of a specified radio tag and position data representing a position that the specified radio tag takes in the specified space; and
position-determining means for determining the position of the robot apparatus from the position data stored in the tag-position storage means, upon collecting the ID data of the specified radio tag.

6. A data-collecting system according to claim 1, further comprising data-reading unit comprising:
reading means for reading the data about the radio tags existing in a closed space; and
output means for outputting data read by the reading means, to the robot apparatus.

7. A data-collecting system according to claim 1, further comprising a unit which outputs electronically recorded, copyrighted data to the robot apparatus.

8. A data-collecting system according to claim 2, wherein the datainanaging apparatus comprises meta-data generating means for converting the property data to meta data.

9. A robot apparatus comprising:
map-data storage means for storing map data representing the geography of a specified space;
route-data storage means for storing route data representing routes existing in the specified space;
mobile means which moves in the specified space in accordance with the map data and the route data; and
ID-data reading means for reading tag ID data items from radio tags existing in the specified space, while being driven by the mobile means.

10. A robot apparatus according to claim 9, further comprising:
tag-position determining means for determining a position that each radio tag takes in the specified space, from the position of the robot apparatus; and
property-data generating means for generating property data by adding, to the ID data time stored in each radio tag, data items representing the position and time at which the ID data item has been acquired.

11. A robot apparatus according to claim 9, further comprising:
tag-position storage means for storing the ID data of a specified radio tag and position data representing a position that the specified radio tag takes in the specified space; and
position-determining means for determining the position of the robot apparatus from the position data stored in the tag-position storage means, upon collecting the ID data of the specified radio tag.
